(19) United States
(12) Patent Application Publication
(10) Pub. No.: US 2014/0319067 A1
(43) Pub. Date: Oct. 30, 2014

(54) Octamethylenephosphonic acid terminated polyamidoamine dendrimer and its use as antiscalant

(71) Applicant: Tongji University, Shanghai (CN)

(72) Inventors: Fengting Li, Shanghai (CN); Bingru Zhang, Shanghai (CN); Fang Chen, Shanghai (CN)

(73) Assignee: Tongji University, Shanghai (CN)

(21) Appl. No.: 14/022,091

(22) Filed: Sep. 9, 2013

(30) Foreign Application Priority Data
Apr. 27, 2013 (CN) 201310152456.5

(51) Int. Cl. C02F 5/04

(52) U.S. Cl. CPC C02F 5/04
USPC 210/712; 562/14

(57) ABSTRACT

A preparation method of octamethylenephosphonic acid terminated, PAMAM dendrimer and application thereof is provided, the dendrimer is prepared by modifying amino groups of 0 generation PAMAM dendrimer with methylene phosphonic acid, a constitutional formula thereof is: (CH₂)ₙ{N[CH₂CH₂CONHCH₂CH₂N(CH₂PO₃H₂)₂]₂}₂, wherein n is a positive integer between 2˜6. The octamethylenephosphonic acid terminated, PAMAM dendrimer has an excellent performance to inhibit scales of CaCO₃, CaSO₄ and Ca₃(PO₄)₂, a very high calcium tolerance, and excellent dispersing performance. The octamethylenephosphonic acid terminated, PAMAM dendrimer is used as an antiscalant in industrial water treatment, and is suitable for the industrial water treatment of boiler, cooling, desalination, and oil production, etc., especially for the industrial water treatment under high calcium concentration.

### BACKGROUND OF THE PRESENT INVENTION

1. Field of Invention

The present invention relates to the technical field of water treatment to inhibit the formation of scales. More particularly, the present invention relates to a process for producing octamethylenephosphonic acid terminated polyamidoamine (PAMAM for short) dendrimer and methods of inhibiting scales formation in industrial water systems, such as boiler, cooling, desalination, and oil production, especially in the industrial water treatment under the condition of high calcium concentration.

2. Description of Related Arts

In industrial water treatment systems, feed water from rivers, lakes, ponds, etc., normally contains large amounts of various dissolved ions, such as Ca²⁺, CO₃²⁻, SO₄²⁻ and PO₄³⁻. As water evaporates or concentrates, these dissolved ions can precipitate and form scales, which accumulate on internal metal surfaces in contact with the water flowing through the system. Typical scales include calcium carbonate, calcium sulfate and calcium phosphate, all of which can cause consequential losses of equipment efficiency.

Scales prevention can be achieved principally by the addition of tailor-made antiscalants including phosphonates containing one or more C—P(O)(OH)₂ groups and polymer-based carboxylic acids.

TABLE 1
Names, abbreviations, molecular weight, and structures of commercial
phosphonates

| | Application | Structure, Molecular weight and |
|---|---|---|
| Name (Abbreviation) | age | Phosphorus content |
| 1-hydroxyethylidene-1,1-diphosphonic acid (HEDP) | 1970s | 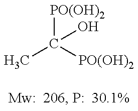 |
| 2-phosphonobutane-1,2,4-tricarboxylic acid (PBTCA) | 1980s | 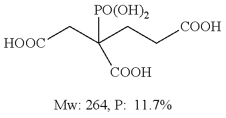 |
| Amino trimethylene phosphonic acid (ATMP) | 1970s | 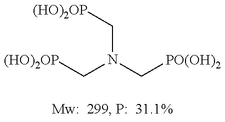 |
| Ethylene diamine tetra(methylene phosphonic acid) (EDTMP) | 1970s | 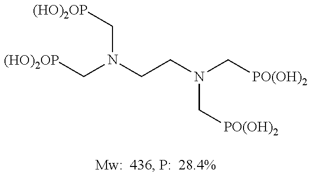 |
| Diethylene triamine penta(methylene phosphonic acid) (DTPMP) | 1970s | 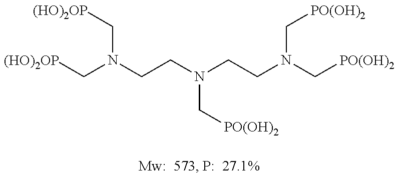 |
| Hexamethylene diamino tetra(methylene phosphonic acid) (HDTMP) | 1980s | 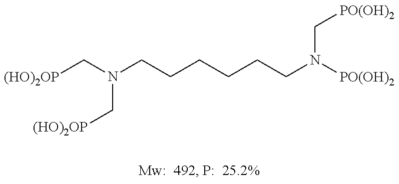 |
| Polyamino polyether tetra(methylene phosphonic acid) (PAPEMP) | 1990s | 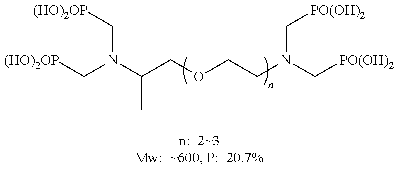 |

Phosphonates commonly used as antiscalants include 1-hydroxy ethylidene-1,1-diphosphonic acid (HEDP), 2-phosphonobutane-1,2,4-tricarboxylic acid (PBTCA), amino trimethylene phosphonic acid (ATMP), ethylene diamine tetra(methylene phosphonic acid) (EDTMP), diethylene triamine penta(methylene phosphonic acid) (DTPMP), hexamethylene diamine tetra(methylene phosphonic acid) (HDTMP), and polyamino polyether tetra(methylene phosphonic) acid (PAPEMP), as shown in table 1.

Besides HEDP and PBTCA, phosphonate antiscalants are mainly compound-based amido methylene phosphonic acid. These phosphonate antiscalants are micromolecular compounds (Mw<600), except that PAPEMP is a macromolecule oligomer. These micromolecular phosphonates are widely used in the industrial water treatment and occupy a large market share, because of low price, good performance of inhibiting calcium carbonate at low calcium ion concentration, and excellent corrosion inhibition performance. However, almost all of micromolecular phosphonate antiscalants have poor calcium ions tolerance, so the micromolecular phosphonates easily react with the calcium ions to form calcium-phosphonate precipitates, under the condition of high concentration calcium and/or high concentration of phosphonates, eventually degrading efficiency of inhibiting calcium carbonate scale. In addition, almost all of micromolecular phosphonates have poor inhibiting efficiency for calcium phosphate scale.

In order to inhibit the calcium phosphate scale, the polymer antiscalants are usually used. Compared with micromolecular phosphonates, the polymer antiscalants have good dispersing performance for calcium carbonate under high hardness, and more suitable for the condition of high hardness.

As an example of phosphonate antiscalants-based amido methylene phosphonic acid, their molecular weights gradually increase from micromolecular compounds ATMP, EDTMP, DTPMP, and HTDMP to oligomer PAPEMP, but their phosphorus content and the calcium tolerance gradually increases. With respect to the micromolecular phosphonates, the micromolecular oligomer PAPEMP has a higher calcium tolerance, and is suitable for the condition of high hardness water. Under low calcium ion concentration, however, the inhibiting scale efficiency of PAPEMP is much poorer than micromolecular phosphonates, and a higher concentration of PAPEMP is required to achieve the same inhibiting scale efficiency.

Since the shortage of water resource is getting worse and worse, saving water and improving efficiency of water utilization have been effective methods for preserving water resource. Therefore, in the industrial water treatment field, cycles of concentration of an industrial recirculating cooling water system and a collection ratio of a reverse osmosis system should be further improved. However, as cycle of concentration of the industrial circulating cooling water is increased and the calcium concentration is increased, the condition of water quality is harsher. Meanwhile, the more stringent environment protecting requirement makes higher requirement on the corrosion and scale inhibition treatment formula of the circulating cooling water. Therefore, it is necessary to seek a polymer phosphonate antiscalant having low cost, high calcium tolerance, and low content of phosphorus.

In recent years, the dendrimer polyamide-amine (PAMAM) attracts more and more attention of people as a new type of polymer. The application in water treatment technology is also increasingly apparent. Especially, amine-terminated PAMAM dendrimers exhibited excellent inhibitory activity for colloid silica scale.

Since the integer generation PAMAM dendrimers have a lot of terminal amino groups, the present invention modifies the terminal amino groups of the PAMAM with methylene phosphonic acid for obtaining the oligomeric methylene phosphonate antiscalant. It is illustrated by experiments that the novel dendrimer has the extreme high toleration of the calcium, and excellent inhibiting performance of calcium carbonate, calcium sulfate and calcium phosphate. Up to now, reports about the octamethylenephosphonic acid terminated PAMAM dendrimer, which is prepared by modifying the terminal amino groups of the PAMAM with the methylene phosphonic acid can not be found across the world, and the structure of the dendrimer is originated by the present invention.

### SUMMARY OF THE PRESENT INVENTION

An object of the present invention is to provide a preparation method of octamethylenephosphonic acid terminated PAMAM dendrimer and its use as antiscalant, in order to overcome the weakness of poor calcium tolerance and poor inhibiting effect for calcium phosphate scale of the conventional micromolecular phosphonates-based methylene phosphonate.

Accordingly, in order to accomplish the above object, the present invention provides a preparation method of the octamethylenephosphonic acid terminated, PAMAM dendrimer (PAMAM(PO₃H₂)₈ for short), wherein a phosphonic acid radical (—P(O)(OH)₂) is connected to a terminal amino group of 0 generation PAMAM dendrimer (PAMAM(NH₂)₄ for short) through a methylene to form octamethylenephosphonic acid terminated, PAMAM dendrimer (PAMAM(PO₃H₂)₈). The dendrimer comprises methylene phosphonic acid group (—CH₂—P(O)(OH)₂), a constitutional formula thereof is as follows:

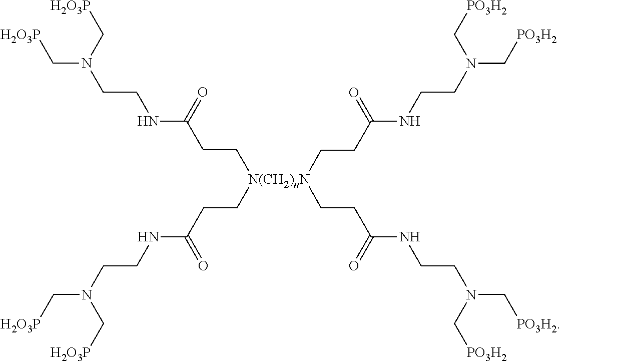

Wherein n is a positive integer between 2˜6.

The general reaction equation and synthetic method can be represented as following.

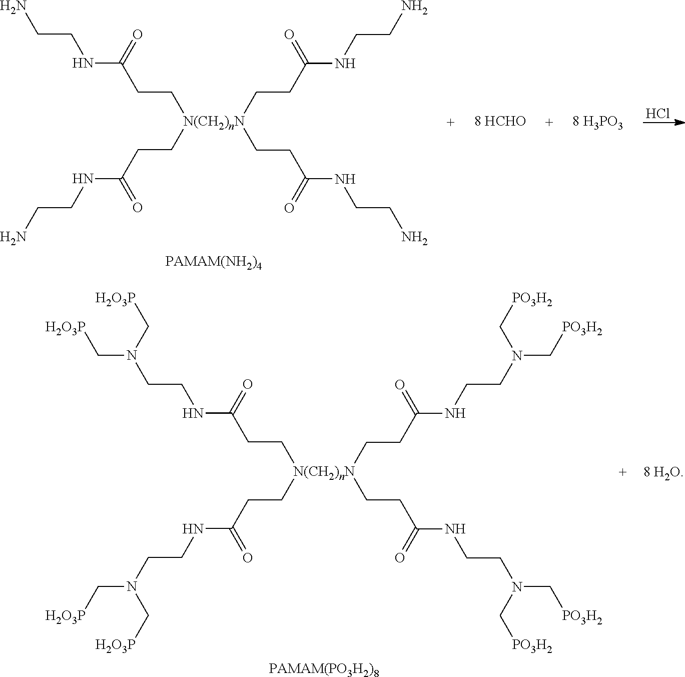

Phosphorous acid and concentrated hydrochloric acid are placed, respectively, in a four-necked flask equipped with a condenser, a stirring, a thermometer and a dropping funnel. Next, 0 generation, PAMAM dendrimer solution (25% in water) is slowly added to above mixture solution with cooling and stirring in such a rate to maintain temperature less than 40° C. The resulting mixture is heated to 85˜90° C., and formaldehyde solution is then added to the mixture with stirring to form a reaction mixture. The temperature of reaction mixture maintained at 85˜90° C. for 1˜2 hour, and then is elevated to 102˜105° C. for a reflux period of 4˜6 hours. After the reflux, reaction mixture is concentrated for about 1 hour at 105° C., and meanwhile, hydrochloric acid is removed off with HCl absorption bottle. Next, the reaction mixture is cooled to ambient temperature, to give an amber transparent liquid product with 30˜40% by weight, i.e., octamethylenephosphonic acid terminated, PAMAM dendrimer (PAMAM(PO₃H₂)₈).

In the present invention, a molar ratio of the 0 generation, PAMAM dendrimer (PAMAM(NH₂)₄), phosphorous acid, formaldehyde and hydrochloric acid is 1:8.0˜8.2:10.0˜11.0:10.0˜10.5.

In the present invention, the 0 generation, PAMAM dendrimer (PAMAM(NH₂)₄) utilized is derived from SIGMA-ALDRICH Co., China. The effective concentration is 20% (methanol solution). When using the 0 generation, PAMAM dendrimer, the methanol is removed by vacuum, and then the PAMAM(NH₂)₄ is dissolved in deionized water by weigh of 25%. The 0 generation, PAMAM dendrimer having the formula:

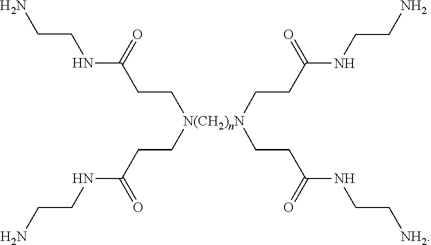

Wherein n is a positive integer between 2˜6.

In the present invention, the phosphorous acid (H₃PO₃) is provided commercially about 99.0% pure.

In the present invention, the formaldehyde (HCHO) is provided commercially about 37% by weight.

In the present invention, the concentrated hydrochloric acid (HCl) is provided commercially about 37% by weight.

In the present invention, the octamethylenephosphonic acid terminated, PAMAM dendrimer is the dendrimer having a terminal group of methylene phosphonic acid and a phosphorus content of lower than 19.6%, which is less than that of other products of methylene phosphonate, as shown in Table 1. The octamethylenephosphonic acid terminated, PAMAM dendrimer is an antiscalant having a relatively low phosphorus content. Studies show that the octamethylenephosphonic acid terminated, PAMAM dendrimer provided in the present invention has a good inhibition scale efficiency under the condition of high concentration calcium, because of a special dendrimer structure thereof. Compared with the conventional phosphonate antiscalants widely used in the market, the octamethylenephosphonic acid terminated, PAMAM dendrimer has a good calcium tolerance, and will provide better inhibiting scale performance under high calcium concentration.

Therefore, the octamethylenephosphonic acid terminated PAMAM dendrimer provided in the present invention is able to effectively inhibit formation of scales, such as calcium carbonate, calcium sulfate, barium sulfate and calcium phosphate. The PAMAM(PO₃H₂)₈ has a good calcium tolerance, and can be widely used in circulating cooling water system having a high concentration multiple, boiler water, oil field water, sea water desalination, etc.

These and other objectives, features, and advantages of the present invention will become apparent from the following detailed description, the accompanying drawings, and the appended claims.

### DETAILED DESCRIPTION OF THE PREFERRED EMBODIMENT

Referring to preferred embodiments, the present invention is illustrated, wherein the scale inhibitors in the following comparison examples are all commercially available.

The comparison example 1: micromolecular phosphonate antiscalant 2-phosphonobutane-1,2,4-tricarboxylic acid (PBTCA).

The comparison example 2: micromolecular phosphonate antiscalant amino trimethylene phosphonic acid (ATMP).

The comparison example 3: micromolecular phosphonate antiscalant ethylenediamine tetra(methylene phosphonic acid) (EDTMP).

The comparison example 4: micromolecular phosphonate antiscalant hexamethylenediamine tetra(methylene phosphonic acid) (HDTMP).

The comparison example 5: oligomer phosphonate antiscalant polyamino polyether tetra(methylene phosphonic acid)(PAPEMP).

### Example 1

### Preparation of Hexamethylenediamine Core, Octamethylenephosphonic Acid Terminated, PAMAM Dendrimer

16.57 g of phosphorous acid (99.0%, 0.200 mol) and 25.69 g of concentrated hydrochloric acid (37%, 0.26 mol) were placed, respectively, in a four-necked flask equipped with a condenser, a stirring, a thermometer and a dropping funnel. Next, 57.20 g of Hexamethylenediamine core, 0 generation, PAMAM dendrimer (H-PAMAM(NH₂)₄ for short) (25%, 0.025 mol) was slowly added to above mixture solution with cooling and stirring in such a rate to maintain temperature less than 40° C. The resulting mixture was heated to 85˜90° C., and 20.27 g of formaldehyde solution (37%, 0.25 mol) was then added to the mixture with stirring to form a reaction mixture. The temperature of reaction mixture maintained at 90° C. for 1 hour, and then was elevated to 102˜105° C. for a reflux period of 4 hours. After the reflux, reaction mixture was concentrated for about 1 hour at 105° C., and meanwhile, hydrochloric acid was removed off with HCl absorption bottle. Next, the reaction mixture was cooled to ambient temperature, to give an amber transparent liquid product with 40% by weight. The identity of the product was confirmed as hexamethylenediamine core, octamethylenephosphonic acid terminated, PAMAM dendrimer (H-PAMAM(PO₃H₂)₈) by nuclear magnetic resonance spectroscopy (NMR) analysis as following: ¹³C NMR (D₂O): δ26.62; 28.93; 32.57; 37.27; 51.02; 52.16; 56.32; 57.30; 173.73; and ³¹P NMR (D₂O): δ10.67.

### Example 2

### Preparation of Butanediamine Core, Octamethylenephosphonic Acid Terminated, PAMAM Dendrimer

16.57 g of phosphorous acid (99.0%, 0.200 mol) and 25.69 g of concentrated hydrochloric acid (37%, 0.26 mol) were placed, respectively, in a four-necked flask equipped with a condenser, a stirring, a thermometer and a dropping funnel. Next, 57.20 g of Butanediamine core, 0 generation, PAMAM dendrimer (B-PAMAM(NH₂)₄ for short) (25%, 0.025 mol) was slowly added to above mixture solution with cooling and stirring in such a rate to maintain temperature less than 40° C. The resulting mixture was heated to 85˜90° C., and 20.27 g of formaldehyde solution (37%, 0.25 mol) was then added to the mixture with stirring to form a reaction mixture. The temperature of reaction mixture maintained at 90° C. for 1 hour, and then was elevated to 102˜105° C. for a reflux period of 4 hours. After the reflux, reaction mixture was concentrated for about 1 hour at 105° C., and meanwhile, hydrochloric acid was removed off with HCl absorption bottle. Next, the reaction mixture was cooled to ambient temperature, to give an amber transparent liquid product with 39% by weight. The identity of the product was confirmed as butanediamine core, octamethylenephosphonic acid terminated, PAMAM dendrimer (B-PAMAM(PO₃H₂)₈) by nuclear magnetic resonance spectroscopy (NMR) analysis as following: ¹³C NMR (D₂O): δ26.82; 32.92; 36.83; 50.44; 53.27; 56.82; 57.11; 175.54; and ³¹P NMR (D₂O): δ69.82.

### Example 3

### Preparation of Ethylenediamine Core, Octamethylenephosphonic Acid Terminated, PAMAM Dendrimer

16.57 g of phosphorous acid (99.0%, 0.200 mol) and 25.69 g of concentrated hydrochloric acid (37%, 0.26 mol) were placed, respectively, in a four-necked flask equipped with a condenser, a stirring, a thermometer and a dropping funnel. Next, 51.60 g of Ethylenediamine core, 0 generation, PAMAM dendrimer (E-PAMAM(NH₂)₄ for short) (25%, 0.025 mol) was slowly added to above mixture solution with cooling and stirring in such a rate to maintain temperature less than 40° C. The resulting mixture was heated to 90° C., and 20.27 g of formaldehyde solution (37%, 0.25 mol) was then added to the mixture with stirring to form a reaction mixture. The temperature of reaction mixture maintained at 90° C. for 1 hour, and then was elevated to 102˜105° C. for a reflux period of 4 hours. After the reflux, reaction mixture was concentrated for about 1 hour at 105° C., and meanwhile, hydrochloric acid was removed off with HCl absorption bottle. Next, the reaction mixture was cooled to ambient temperature, to give an amber transparent liquid product with 39% by weight. The identity of the product was confirmed as ethylenediamine core, octamethylenephosphonic acid terminated, PAMAM dendrimer (E-PAMAM(PO₃H₂)₈) by nuclear magnetic resonance spectroscopy (NMR) analysis as following: ¹³C NMR (D₂O): δ34.02; 36.41; 49.92; 50.50; 56.62; 57.18; 176.01; and ³¹P NMR (D₂O): δ10.17.

### Example 4

### Inhibition Scale Efficiency Test

The static testes for the inhibition efficiency of the antiscalants on calcium carbonate, calcium sulfate and calcium phosphate scale precipitation were performed as following methods.

Static inhibition efficiency test for calcium carbonate were performed by referring to national standard of the People's Republic of China, calcium carbonate deposition method for testing scale inhibiting performance of water treatment agent (GB/T 16632-2008). The 500 mL of test solution containing 10 mg·L⁻¹ of antiscalant (dry basis), 240 mg·L⁻¹ of Ca²⁺ and 732 mg·L⁻¹ of HCO₃⁻ were prepared by adding calculated volume antiscalant stock solution, calcium stock solution, bicarbonate stock solution and double distilled water, respectively, to a glass bottle. The pH of each test solution was adjusted to 9.0 using borate buffer Solution. The bottles were incubated in a water bath for 18 hour at 80° C. After cooling, an aliquot quantity was filtered through 0.22 μm filter paper, and then the calcium concentration in the filtrate was measured using the standard EDTA titration method. Meanwhile, the control test in the absence of antiscalant was conducted.

Static inhibition efficiency test for calcium sulfate were performed similar to the static calcium carbonate inhibition efficiency. The 500 mL of test solution contained 5 mg·L⁻¹ of antiscalant (dry basis), 2200 mg·L⁻¹ of Ca²⁺ and 7350 mg·L⁻¹ of SO₄⁻. It was adjusted to 7.00±0.1 by the addition of HCl and/or NaOH solution (10%). The bottles were incubated in a water bath for 18 hour at 80° C. After cooling, an aliquot quantity was filtered through 0.22 μm filter paper, and then the calcium concentration in the filtrate was measured using the standard EDTA titration method. Meanwhile, the control test in the absence of antiscalant was conducted.

Static inhibition efficiency test for calcium phosphate were performed by referring to national standard of the People's Republic of China, calcium phosphate deposition method for testing scale inhibiting performance of water treatment agent (GB/T 22626-2008). The 500 mL of test solution containing 10 mg·L⁻¹ of antiscalant (dry basis), 240 mg·L⁻¹ of Ca²⁺ and 5 mg·L⁻¹ of PO₄³⁻ were prepared by adding calculated volume antiscalant stock solution, calcium stock solution, phosphate stock solution and double distilled water, respectively, to a glass bottle. The pH of each test solution was adjusted to 9.0 using borate buffer Solution. The bottles were incubated in a water bath for 18 hour at 80° C. After cooling, an aliquot quantity was filtered through 0.22 μm filter paper, and then the phosphate concentration in the filtrate was measured using the ammonium molybdate spectrophotometric method. Meanwhile, the control test in the absence of antiscalant was conducted.

The inhibition scale efficiency of the antiscalant was calculated by:

Inhibition (%)=[(Cᵢ+C_{control})/(C₀−C_{control})]×100%, wherein Cᵢ is the calcium or phosphonate concentration of the sample with the addition of the polymeric inhibitor after incubation, C_{control} is the calcium or phosphonate concentration of the sample with the addition of the scale inhibitor before incubation, C₀ is the calcium or phosphonate concentration of the sample without of the addition of the scale inhibitor after incubation.

Results of inhibition efficiency tests are illustrated in table 3.

Table 3 summarizes static inhibition scale efficiency tests for the octamethylenephosphonic acid terminated, PAMAM dendrimer (PAMAM(PO₃H₂)₈) as well as several prior art antiscalants. The inhibition efficiency on CaCO₃, CaSO₄ and Ca₃(PO₄)₂ of the PAMAM(PO₃H₂)₈ is far better than micromolecular phosphonate antiscalants PBTCA, ATMP, EDTMP and HTDMP in comparison examples 1˜4, and also better than macromolecule oligomer phosphonate PAPEMP.

TABLE 3
Result of inhibition scale efficiency test

| | | Inhibition | Inhibition | Inhibition |
|---|---|---|---|---|
| | | efficiency for | efficiency for | efficiency for |
| Ex. No. | Antiscalants | CaCO₃ (%) | CaSO₄ (%) | Ca₃(PO₄)₂ (%) |
| Example 1 | H-PAMAM(PO₃H₂)₈ | 75.34 | 97.01 | 50.11 |
| Example 2 | B-PAMAM(PO₃H₂)₈ | 76.12 | 95.69 | 48.54 |
| Example 3 | E-PAMAM(PO₃H₂)₈ | 77.70 | 94.38 | 48.63 |
| Comparison | PBTCA | 70.98 | 25.73 | 14.58 |
| example 1 | | | | |
| Comparison | ATMP | 54.21 | 70.12 | 22.62 |
| example 2 | | | | |
| Comparison | EDTMP | 57.81 | 76.86 | 22.33 |
| example 3 | | | | |
| Comparison | HTDMP | 65.77 | 79.22 | 23.19 |
| example 4 | | | | |
| Comparison | PAPEMP | 74.57 | 90.29 | 40.34 |
| example 5 | | | | |

### Example 5

### The Effects of the Antiscalant Concentration on the Inhibition Calcium Carbonate Scale Efficiency

The 500 mL of test solution containing a certain concentration of antiscalant, 200 mg·L⁻¹ of Ca²⁺ (500 mg·L⁻¹ as CaCO₃) and 732 mg·L⁻¹ of HCO₃⁻ was prepared by adding calculated volume antiscalant stock solution, calcium stock solution, bicarbonate stock solution and double distilled water, respectively, to a glass bottle. The pH of each test solution was adjusted to 9.0 by using borate buffer Solution. The bottles were incubated in a water bath for 10 hour at 80° C. After cooling, an aliquot quantity was filtered through 0.22 μm filter paper, and then the calcium concentration in the filtrate was measured using the standard EDTA titration method. Meanwhile, the control test in the absence of antiscalant was conducted.

The effect of antiscalant concentrations on the inhibition calcium carbonate efficiency is illustrated in Table 4.

TABLE 4
The effect of antiscalant concentrations on the inhibition calcium carbonate
efficiency

| | | Inhibition efficiency for CaCO₃ (%) | | | | | | | |
|---|---|---|---|---|---|---|---|---|---|
| | | Antiscalant Concentration (mg · L⁻¹) | | | | | | | |
| Ex. No. | Antiscalants | 2 | 4 | 6 | 8 | 10 | 12 | 14 | 16 |
| Example 1 | H-PAMAM(PO₃H₂)₈ | 31.09 | 46.22 | 61.21 | 93.91 | 97.55 | 100 | 100 | 100 |
| Example 2 | B-PAMAM(PO₃H₂)₈ | 32.32 | 48.01 | 63.87 | 92.45 | 96.33 | 99.01 | 100 | 100 |
| Example 3 | E-PAMAM(PO₃H₂)₈ | 34.29 | 50.32 | 64.51 | 92.63 | 95.12 | 96.23 | 100 | 100 |
| Comparison | PBTCA | 57.12 | 66.39 | 72.94 | 78.23 | 82.53 | 86.36 | 86.23 | 84.19 |
| example 1 | | | | | | | | | |
| Comparison | ATMP | 50.55 | 60.18 | 69.54 | 73.89 | 72.31 | 70.99 | 70.17 | 70.15 |
| example 2 | | | | | | | | | |
| Comparison | EDTMP | 48.11 | 56.32 | 66.84 | 73.83 | 80.58 | 79.45 | 78.23 | 77.22 |
| example 3 | | | | | | | | | |
| Comparison | HTDMP | 42.88 | 54.43 | 61.84 | 70.86 | 82.62 | 85.75 | 86.22 | 87.58 |
| example 4 | | | | | | | | | |
| Comparison | PAPEMP | 30.64 | 46.33 | 64.11 | 77.22 | 84.24 | 90.22 | 95.32 | 100 |
| example 5 | | | | | | | | | |

Table 4 summarizes the effect of the antiscalant concentration on the inhibition calcium carbonate scale efficiency. It is shown that micromolecular phosphonate antiscalants exhibit an obvious “threshold effect”, indicating that after the dosage of phosphonate exceeds a certain value (12 mg·L⁻¹ for PBTCA, 8 mg·L⁻¹ for ATMP, 10 mg·L⁻¹ for EDTMP, and 14 mg·L⁻¹ for HTDMP) the inhibition efficiency is not enhanced, but will reduce with further increase of phosphonate concentration. Because the micromolecular phosphonate antiscalants can combine with the calcium ions to form Ca-phosphonate precipitates, which can decreases the effective concentration of the antiscalant and causes a decreasing of the inhibition scale efficiency.

However, the inhibition efficiency of the octamethylenephosphonic acid terminated, PAMAM dendrimer (PAMAM(PO₃H₂)₈) prepared in the present invention improves and macromolecule oligomeric PAPEMP with the increase of its concentration in the range of experimental concentrations. When its concentration exceeds 8 mg·L⁻¹, the inhibition scale efficiency of PAMAM(PO₃H₂)₈ is better than all of the micromolecular phosphonate antiscalants in the comparison examples 1˜4. The PAMAM(PO₃H₂)₈ is able to inhibit the formation of calcium carbonate completely, and is better than the oligomer phosphonate PAPEMP in comparison example 5, which shows that octamethylenephosphonic acid terminated, PAMAM dendrimer (PAMAM(PO₃H₂)₈) in the present invention is not easy to combine with the calcium ions to form Ca-phosphonate precipitates.

Furthermore, when the concentration of the antiscalant H-PAMAM(PO₃H₂)₈ is low, the scale inhibition performance of H-PAMAM(PO₃H₂)₈ thereof is lower than the scale inhibition performance of the B-PAMAM(PO₃H₂)₈ and the E-PAMAM(PO₃H₂)₈. But when the concentration of the antiscalant H-PAMAM(PO₃H₂)₈ is high, the scale inhibition performance of H-PAMAM(PO₃H₂)₈ thereof is higher than the scale inhibition performance of the B-PAMAM(PO₃H₂)₈ and the E-PAMAM(PO₃H₂)₈.

### Example 6

### The Inhibition Scale Efficiency Under the Condition of High Calcium Concentration

The 500 mL of test solution containing a certain concentration of antiscalant, 600 mg·L⁻¹ of Ca²⁺ (1500 mg·L⁻¹ as CaCO₃) and 750 mg·L⁻¹ of HCO₃⁻ was prepared by adding calculated volume antiscalant stock solution, calcium stock solution, bicarbonate stock solution and double distilled water, respectively, to a glass bottle. The pH of each test solution was adjusted to 9.0 by using borate buffer Solution. The bottles were incubated in a water bath for 10 hour at 80° C. After cooling, an aliquot quantity was filtered through 0.22 μm filter paper, and then the calcium concentration in the filtrate was measured using the standard EDTA titration method. Meanwhile, the control test in the absence of antiscalant was conducted.

TABLE 5
The effect of antiscalant concentrations on the inhibition calcium
carbonate efficiency under the calcium-enriched condition

| | | Inhibition efficiency for | | | | |
|---|---|---|---|---|---|---|
| | | CaCO₃ (%) Antiscalant | | | | |
| | | Concentration (mg · L⁻¹) | | | | |
| Ex. No. | Antiscalants | 5 | 10 | 20 | 30 | 40 |
| Example 1 | H-PAMAM(PO₃H₂)₈ | 20.34 | 55.53 | 85.96 | 86.44 | 88.33 |
| Example 2 | B-PAMAM(PO₃H₂)₈ | 21.65 | 57.80 | 84.51 | 85.51 | 87.55 |
| Example 3 | E-PAMAM(PO₃H₂)₈ | 24.55 | 58.32 | 79.96 | 83.21 | 85.96 |
| Comparison | PBTCA | 20.94 | 44.11 | 45.22 | 35.22 | 34.21 |
| example 1 | | | | | | |
| Comparison | ATMP | 15.06 | 21.92 | 30.4 | 20.33 | 18.22 |
| example 2 | | | | | | |
| Comparison | EDTMP | 17.21 | 30.89 | 40.99 | 31.99 | 24.38 |
| example 3 | | | | | | |
| Comparison | HTDMP | 16.9 | 40.36 | 55.06 | 45.06 | 40.19 |
| example 4 | | | | | | |
| Comparison | PAPEMP | 15.33 | 44.11 | 66.22 | 77.44 | 80.1 |
| example 5 | | | | | | |

Table 5 summarizes the effect of the antiscalant concentration on the inhibition calcium carbonate scale efficiency under the condition of high calcium concentration. It is shown that the H-PAMAM(PO₃H₂)₈, the B-PAMAM(PO₃H₂)₈ and the E-PAMAM(PO₃H₂)₈ in the present invention have an excellent scale inhibiting performance under the condition of high calcium concentration. With the increasing of the dosage of the antiscalants, micromolecular phosphonate antiscalants in comparison examples 1˜4 combine easily with the higher concentration calcium ions to form Ca-phosphonate precipitates, which causes the sharp decreasing of the inhibiting scale efficiency. However, the PAMAM(PO₃H₂)₈ in the present invention can still remain a high scale inhibiting rate, and is better than the oligomer phosphosnate PAPEMP in comparison example 5, which shows that the octamethylenephosphonic acid terminated, PAMAM dendrimer in the present invention is not easy to combine with the calcium ions to form Ca-phosphonate precipitates, and has a good calcium tolerance.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An octamethylenephosphonic acid terminated PAMAM dendrimer, having a constitutional formula illustrated as follows: 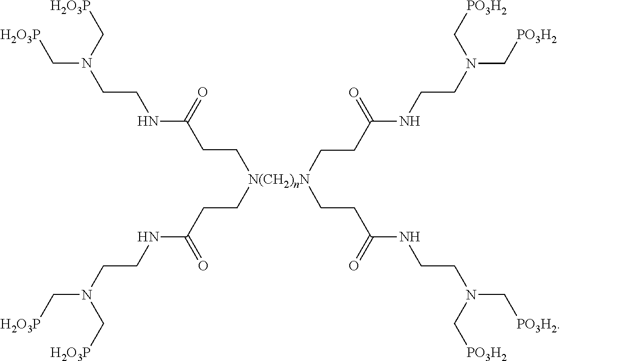
wherein n is a positive integer between 2˜6.

2. A preparation method of said octamethylenephosphonic acid terminated PAMAM dendrimer, as recited in claim 1, comprising: preparing the octamethylenephosphonic acid terminated PAMAM dendrimer by modifying amino groups of 0 generation PAMAM dendrimer with methylene phosphonic acid.

3. The method, as recited in claim 2, specifically comprising steps of: thoroughly mixing phosphorous acid with concentrated hydrochloric acid, adding a water solution of the 0 generation PAMAM dendrimer slowly while stirring and cooling, wherein when adding, a temperature of the solution is kept below 40° C.; heating to 85˜90° C. after adding, then adding the water solution of formaldehyde while stirring; keeping the temperature at 85˜90° C. for 1˜2 hours after adding; heating to a reflux temperature of 102˜105° C., keeping refluxing for 4˜6 hours; turning off a reflux device and opening a hydrochloric acid absorption bottle for concentrating the mixture, wherein a concentration temperature is 102˜105° C.; and cooling to a room temperature until no HCL is emitted for obtaining amber transparent liquid with a solid content of 30˜40%, wherein the amber transparent liquid is the octamethylenephosphonic acid terminated PAMAM dendrimer.

4. The method, as recited in claim 2, wherein the constitutional formula of the 0 generation PAMAM dendrimer is as follows: 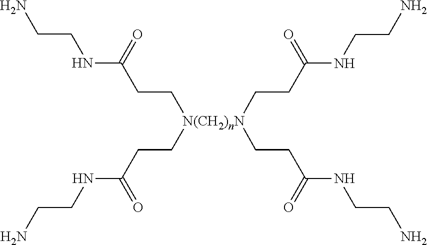
wherein n is a positive integer between 2˜6.

5. The method, as recited in claim 3, wherein the constitutional formula of the 0 generation PAMAM dendrimer is as follows: 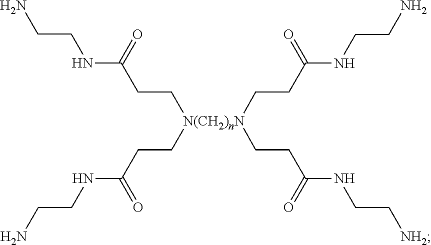
wherein n is a positive integer between 2˜6.

6. The method, as recited in claim 3, wherein a molar ratio of the 0 generation PAMAM dendrimer, the phosphorous acid, the formaldehyde and the hydrochloric acid is 1:(8.0˜8.2):(10.0˜11.0):(10.0˜10.5).

7. The method, as recited in claim 4, wherein a molar ratio of the 0 generation PAMAM dendrimer, the phosphorous acid, the formaldehyde and the hydrochloric acid is 1:(8.0˜8.2):(10.0˜11.0):(10.0˜10.5).

8. The method, as recited in claim 5, wherein a molar ratio of the 0 generation PAMAM dendrimer, the phosphorous acid, the formaldehyde and the hydrochloric acid is 1:(8.0˜8.2):(10.0˜11.0):(10.0˜10.5).

9. A method of treating industrial water, comprising: applying the octamethylenephosphonic acid terminated PAMAM dendrimer according to claim 1, as dispersing antiscalant, which has a CaCO₃, CaSO₄ and Ca₃(PO₄)₂ scale inhibition function, and adapts to recirculating cooling water, oilfield flooding and reverse osmosis industrial water treatment.

10. The method, as recited in claim 9, wherein the industrial water systems are under high calcium concentration.
